(19) United States
(12) Patent Application Publication
(10) Pub. No.: US 2024/0295237 A1
(43) Pub. Date: Sep. 5, 2024

(54) Fastener System for Rapid Insertion, Extraction, and Rotation on Bolts and Threaded Objects

(71) Applicant: Darryl Massey, Santa Monica, CA (US)

(72) Inventor: Darryl Massey, Santa Monica, CA (US)

(21) Appl. No.: 18/592,434

(22) Filed: Feb. 29, 2024

Related U.S. Application Data
(60) Provisional application No. 63/449,526, filed on Mar. 2, 2023.
(60) Provisional application No. 63/449,515, filed on Mar. 2, 2023.

(51) Int. Cl. F16B 37/08; F16L 19/025

(52) U.S. Cl. CPC F16B 37/0864; F16L 19/025

(57) ABSTRACT

A threaded fastener with linear and rotational modes of operation is disclosed. The fastener generally includes an outer shell and inner sleeve. The outer shell (150) is configured to rotate with respect to the inner sleeve (110), thus allowing the user to select between the linear and rotational modes of operation. In the linear mode, a bolt can be inserted into the fastener with a rapid linear motion in which the fastener effectively slides over the helical threads of the bolt and up against the workpiece. The user can then turn the outer shell to engage the rotational mode of operation in which the fastener is seated onto the threads of the bolt, comparable to a standard nut. The inner sleeve comprises a plurality of primary pawls (114) with helical threads (120) and one or more secondary pawls (170) with ratchet threads. Ratchet threads enable the bolt to slide into the fastener with the linear motion, but also inhibit the bolt from sliding out of the fastener. Thus, the ratchet threads do not interfere with the insertion of the bolt, but still prevent the bolt from inadvertently sliding out of the fastener before the user has locked the fastener into the rotational mode.

### CROSS-REFERENCE TO RELATED APPLICATION(S)

This application claims the benefit of U.S. Provisional Patent Application Ser. No. 63/449,526 filed Mar. 2, 2023, titled “A faster fastener that quickly and easily engages or disengages a threaded fastener” and U.S. Provisional Patent Application Ser. No. 63/449,515 filed Mar. 2, 2023, titled “Fast-tie three-piece fastening device which replaces the conventional nut-and-bolt system,” which are hereby incorporated by reference herein for all purposes.

### TECHNICAL FIELD

The present invention relates generally to fasteners and more specifically to threaded fasteners with a quick install and release function which eliminates the need to fully screw or unscrew the fastener rotationally.

### BACKGROUND

There are many classes of fastening devices. Perhaps the oldest and most common is the nail. This device relies on friction between the nail shaft and the material (generally wood) into which it is driven to hold two or more pieces of the material together. Other devices, such as the rivet, rely on the malleability of the fastener to allow the end of the fastener to be enlarged to a point where it cannot be accidentally withdrawn. Other common fastening devices are the threaded fasteners most common of which is the nut and bolt. This system employs a male and a female component which have matching helical threads. The nut must be screwed all the way up the threaded bolt until it engages the parts being held together. Another common device for fastening is the cable tie which comprises a plastic strap with a plurality of miniature ramp-like teeth. At one end of the strap is a receiver which contains a pawl which engages the teeth as the strap as it is pulled through the receiver thereby preventing the strap from being pulled in the reverse direction.

The main disadvantage of the nut and bolt system is the time and difficulty involved in screwing or unscrewing the nut. This is a particular problem when assembly time is critical or when there is limited room to swing the tightening device such as a wrench. The main disadvantage of the cable tie is the inability to tension the resulting closure.

There is therefore a need for a fastener system that enables rapid insertion, rapid extraction, and tension while preventing cross threading.

### SUMMARY

The invention in the following embodiments features a novel fastener that can replace a standard threaded nut in a nut & bolt combination. The fastener generally includes an outer shell and inner sleeve concentrically positioned in the outer shell. A bolt or other threaded object can be inserted into the fastener and a workpiece captured between the head of the bolt and the fastener in the same manner as a nut and bolt.

The outer shell is configured to rotate with respect to the inner sleeve, thus allowing the user to select between a linear mode of operation and a rotational mode of operation. In the linear mode, the bolt can be inserted into the fastener with a rapid linear motion. In this mode, the fastener slides over the helical threads of the bolt and up against the workpiece, thus obviating the need for the user to manually turn the fastener to thread it up to the workpiece. Once pressed against the workpiece, the user can turn the outer shell to engage the rotational mode of operation. In this mode, the fastener is seated onto the threads of the bolt and can only traverse those threads through rotation of the entire fastener, comparable to a standard nut.

In the preferred embodiment, the fastener comprises (1) an outer shell with a plurality of apertures and a plurality of tensioning elements configured to rotate the outer shell; and (2) an inner sleeve with a plurality of primary pawls and (3) a flange. Each of the primary pawls is configured to selectively engage the helical threads of a bolt or other threaded structure depending on the operational mode. The flange, in turn, enables the user to push the outer shell and have the force transferred to the inner shell when pressing the inner sleeve and bolt together. In normal operation, the apertures align with the primary pawls when the primary pawls are in the deflected position, and the shell wall aligns with the primary pawls when the primary pawls are in the biased position. However, when a tooth-on-tooth scenario occurs, the primary pawls fail to seat within the helical threads of the bolt or threaded object. To remedy this scenario, the outer shell is configured to abut the primary pawls when they are improperly deflected above their seated position in the helical threads. After the shell wall abuts the primary pawls, the rotation of the outer shell causes the primary pawls (and inner shell) to rotate across the helical threads until the primary pawls are finally seated within helical threads.

The plurality of primary pawls comprise a portion of helical thread configured to engage the helical threads of the bolt or other threaded structure. The portion of helical threads skip over the bolt threads in the linear mode, and seat against the bolt threads in the rotational mode. In general, the primary pawls are biased inward against the bolt threads, but can flex upward away from the threads in the linear mode. The flex is achieved using a hinge or flexure joint incorporated into the inner sleeve. When flexed upward, the primary pawls flex up into apertures or recesses built into the outer shell. When the outer shell is rotated and the apertures moved away, the shell blocks the upward movement, thus fixing the pawl threads in a position in engagement with the bolt threads. The threads can be that of a bolt or hose, for example.

In some embodiments, the fastener further includes one or more secondary pawls, each of the secondary pawls comprising a ratchet thread configured to: enable the bolt to slide into the fastener when configured in the linear mode; and inhibit the bolt from sliding out of the fastener when configured in the linear mode. Thus, the ratchet threads do not interfere with the insertion of the bolt, but still prevent the bolt from inadvertently sliding out of the fastener before the user has locked the fastener into the rotational mode. The secondary pawls thus enable the user the ability to insert the bolt and let go of the bolt without it falling apart. In some embodiments, the secondary pawls employ a release tab to pull the ratchet threads of the secondary pawls off the bolt threads in order to remove the bolt.

The secondary pawls can be configured to catch a corresponding set of ratchet threads on the inner sleeve, ratchet threads in a longitudinal channel in the bolt, ratchet threads incorporated into the helical threads of the threaded object, or ratchet threads interleaved with the helical threads of the threaded object, for example. A ratchet thread, as used herein, generally refers to an asymmetric thread tooth having a vertical face and a sloped face. The vertical face, being perpendicular to the longitudinal axis of a bolt, can “catch” the vertical face of another ratchet tooth, while the sloped face can “slide” over the sloped face of another ratchet tooth.

In view of the foregoing disadvantage inherent in the known types of threaded fasteners now present in the prior art, the present invention provides a new fastening system which all but eliminates the need to screw or unscrew the fastener, thereby reducing the time and difficulty involved in usage.

The general purpose of the present invention, which is be described subsequently in greater detail, is to provide a new fastening system that has many of the advantages of the conventional threaded nut and bolt and has many novel features that result in a much improved fastening system which is not anticipated, rendered obvious, suggested, or even implied by any of the prior art, either alone or in any combination thereof.

A primary object of the present invention is to provide a fastening system that is a substantial improvement upon the conventional nut and bolt system in that the time and difficulty involved and tightening or removing the device is substantially reduced. An additional advantage of this design is that it is virtually impossible to cross-thread and is potentially flexible.

The above discussion has outlined, rather broadly, the more important features of the present invention in order that the detailed description thereof may be better understood, and in order that the present contribution to the art maybe better appreciated. There are additional features of the invention that will be described hereinafter. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

To the accomplishment of the above and related objects this invention may be embodied in the form illustrated in the accompanying drawings, attention being called to the fact, however, that the drawings are illustrative only and that changes may be made in the specific construction illustrated.

### BRIEF DESCRIPTION OF THE DRAWINGS

The present invention is illustrated by way of example and not limitation in the figures of the accompanying drawings, and in which:

FIG. 1 is an oblique view of the fastener system in the assembled condition, in accordance with the first embodiment of the present invention;

FIG. 2 is an oblique exploded view of the fastener system, in accordance with the first embodiment of the present invention;

FIG. 3 is an oblique sectional view with the primary pawl deflected outward, in accordance with the first embodiment of the present invention;

FIG. 4 is an oblique sectional view with the primary pawl pressed inward, in accordance with the first embodiment of the present invention;

FIG. 5 is a rear view of the fastener system depicting the detent feature, in accordance with the first embodiment of the present invention;

FIG. 6 is an oblique view of the fastener system in the assembled condition, in accordance with the second embodiment of the present invention;

FIG. 7 is an oblique exploded view of the fastener system, in accordance with the second embodiment of the present invention;

FIG. 8 is an oblique partial sectional view of the fastener system, in accordance with the second embodiment of the present invention;

FIG. 9 is an oblique view of the fastener system in the assembled condition, in accordance with the third embodiment of the present invention;

FIG. 10 is an oblique exploded view of the fastener system, in accordance with the third embodiment of the present invention;

FIG. 11 is a detail of the dual-thread bolt, in accordance with the third embodiment of the present invention;

FIG. 12 is a cross sectional view of the fastener system, in accordance with the third embodiment of the present invention;

FIG. 13 is a detail of the fastener system of FIG. 12, in accordance with the third embodiment of the present invention;

FIG. 14 is an oblique partial section view of the fastener system, in accordance with the third embodiment of the present invention;

FIG. 15 is a detail of the fastener system of FIG. 14, in accordance with the third embodiment of the present invention;

FIG. 16 is an oblique view of the fastener system in the assembled condition, in accordance with the fourth embodiment of the present invention;

FIG. 17 is an oblique cross sectional view of the fastener system, in accordance with the fourth embodiment of the present invention;

FIG. 18 is an exploded view of the fastener system, in accordance with the fourth embodiment of the present invention;

FIG. 19 is an oblique view of the fastener system in the assembled condition, in accordance with the fifth embodiment of the present invention;

FIG. 20 is an exploded view of the fastener system, in accordance with the fifth embodiment of the present invention;

FIG. 21 is an oblique view of the fastener system, in accordance with the fifth embodiment of the present invention;

FIG. 22 is a detail of the fastener system of FIG. 21, in accordance with the fifth embodiment of the present invention;

FIG. 23 is an oblique view of the fastener system in the assembled condition, in accordance with the sixth embodiment of the present invention;

FIG. 24 is an exploded view of the fastener system, in accordance with the sixth embodiment of the present invention; and

FIGS. 25A-25B are oblique views of a fastener system with an extraction alignment mechanism in an unlocked and locked configuration, respectively, in accordance with one embodiment of the present invention.

### DETAILED DESCRIPTION OF THE PREFERRED EMBODIMENT

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

The present invention comprises a fastener configured to attach to various threaded objects including, but not limited to, threaded bolts, threaded rods, threaded studs, threaded hoses, and threaded pipes, for example, having a standard or proprietary thread pattern. Standard thread patterns are defined by various organizations including the American National Standards Institute, American Society of Mechanical Engineers, SAE International, American Society for Testing and Materials, International Organization for Standardization, German Institute for Standardization), and British Association. This class of threaded objects with which the present invention may operate is referred to herein generally as “bolts”. The fastener, in combination with a bolt, may be used to secure one or more items together. These items are collectively referred to herein as the “workpiece”.

### First Embodiment

The first embodiment of the fastener is configured to engage a threaded bolt in two modes: (a) a linear mode in which the fastener slides over the threads of the bolt, and (b) a rotational mode in which the fastener seats within the threads of the bolt. In various embodiments presented herein, the fastener—referred to as the linear-rotational (LR) fastener 100—reproduces the functions of a standard threaded nut while providing additional functions not afforded by such a standard nut. The RL fastener, therefore, can replace a conventional nut while providing additional functionality for which there is a long-felt need.

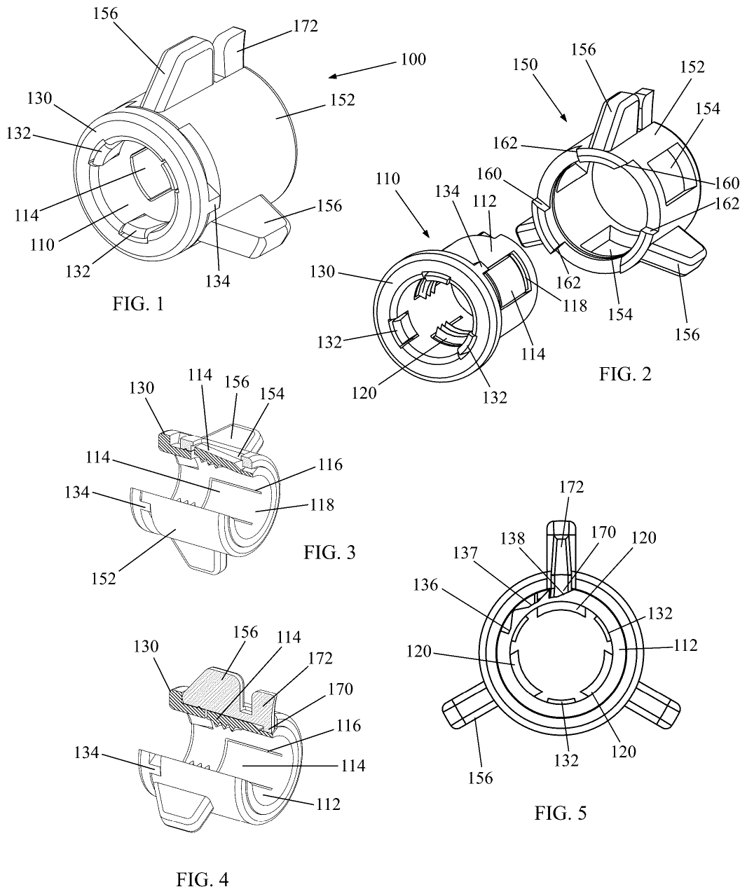

The first embodiment of the LR fastener is illustrated in FIGS. 1-5. In this first embodiment, the LR fastener 100 comprises an inner sleeve 110 and an outer shell 150. The inner sleeve 110 includes a sleeve wall 112 while the outer shell 150 includes a shell wall 152, both of which are generally cylindrical in shape. In operation, the inner sleeve 110 concentrically nests within the outer shell 150 with their longitudinal axes in alignment, as shown in FIG. 1. A small gap between the outer shell 150 and an inner sleeve 110 is sufficient to allow the outer shell 150 to rotate relative to the inner sleeve 110 with substantially no friction therebetween.

In the first preferred embodiment, the inner sleeve 110 is a single unitary structure in which various components are integrally formed. Similarly, the outer shell 150 is also a single unitary structure in which various components are integrally formed. These components are configured to cooperate and selectively interact with one another to perform the various functions described in detail herein.

A first set of integral components includes at least one and preferably a plurality of primary pawls 114, each of which is integrally formed into the inner sleeve 110, although a separate structure is also contemplated. The primary pawls 114 are configured to (a) linearly slide across the helical threads of a bolt (not shown), and (b) then—after engaging with the work piece—rotate with the helical threads after being seated onto the helical threads of the bolt.

Each of the primary pawls 114 is characterized by a generally rectangular shape. The pawls 114 are separated from the sleeve wall 112 of the inner sleeve 110 by a gap 116 on three sides of the rectangle and attached on the fourth side 118. The length and thickness of the fourth side 118 is configured to enable each pawl 114 to flex with respect to the sleeve wall 112, thereby serving as a hinge or flexure joint 118. Alternatively, a separate pawl and hinge may also be employed. While the primary pawls 114 are biased inward toward a bolt, they can flex outward up to approximately 5-10 degrees with respect to the sleeve wall 112 without damage.

Each of the three pawls 114 includes at least one portion of helical thread 120. In profile, the portions of helical thread 120 appear to be teeth in cross section. The teeth have the shape of an isosceles triangle with a sloping face on either side. This slope, i.e., the pitch, is configured to match the slope of the helical threads on the corresponding bolt.

When the inner sleeve 110 and outer shell 150 are attached (assembled) to one another, the three pawls 114 of the inner sleeve 110 generally align/coincide with one of two different structures in the outer shell 150. In the linear mode, each of the primary pawls 114 radially coincides with one of the shell apertures 154. This enables the three pawls 114 to flex radially outward, thereby permitting the primary pawls to slide over the threads of the bolt as it is inserted into the LR fastener 100 with a linear motion.

In the radial mode, each of the primary pawls 114 radially coincides with shell wall 152 of the outer shell 150. In this embodiment, the shell wall 152, which is solid, is configured to prevent the pawls 114 from flexing outward. Thus, in the radial mode, the threads 120 of the primary pawls 114 are forced to engage the threads of the bolt, thereby permitting only helical/rotational motion of the inner sleeve 110 relative to the bolt.

The inner sleeve 110 further includes a sleeve flange 130 integrally formed with the inner wall 112. The sleeve flange 130 projects radially outward from one end of the sleeve wall 112. That is to say, the outer diameter of the flange 130 exceeds the outer diameter of the inner all 112. The end of the inner sleeve 110 with the sleeve flange 130 is referred to herein as the “workpiece end” since it abuts, secures, or otherwise captures a workpiece between the fastener 100 and the head of a bolt (not shown). In the preferred embodiment, the outer diameter of the sleeve flange 130 is approximately equal to the diameter of the shell wall 152 of the outer shell 150. In operation, the sleeve flange 130 resides between the workpiece and the outer shell 150.

The inner sleeve 110 in the preferred embodiment includes a plurality of gripping tabs 132, each gripping tab integrally connected to the sleeve wall 112 by means of a hinge or flexure joint. The gripping tabs 132 are biased inwardly so as to make contact with the helical threads of a bolt. The biasing force is sufficiently large that the gripping tabs 132 firmly grab the helical threads, thereby inhibiting the bolt from coming to rest at a longitudinal position in which the gripping tabs are any place other than the seated position between helical threads.

The outer shell 150 in the preferred embodiment further includes a plurality of tensioning wings 156 integrally formed with the shell wall 152. Each tensioning wing 156 is generally planar in shape and projects both radially and longitudinally. The tensioning wings 156 enable the user to apply a torque about the longitudinal axis of the outer shell 150, thereby rotating the outer shell relative to the inner sleeve 110 or relative to the bolt.

In the preferred embodiment, the sleeve flange 130 includes at least one stop lug 134 that projects longitudinally from the sleeve flange in the direction opposite from the workpiece. The stop lug 134 permits the outer shell 150 to rotate relative to the inner sleeve 110 on the order of about 60 degrees (between 40 degrees and 115 degrees). When the user rotates the outer shell 150 in a clockwise direction relative to the inner sleeve 110, for example, the outer shell turns until the stop lug 134 abuts a tensioning stop wall 162. When the user rotates the outer shell 150 in a counter-clockwise direction relative to the inner sleeve 110, for example, the outer shell turns until the stop lug 134 abuts a release stop wall 160. Thus, the outer shell 150 can rotate relative to the inner sleeve 110 to the extent that the stop lug 134 can rotate between the release stop wall 160 and the tensioning stop wall 162.

The first embodiment of the LR fastener 100 further includes a locking mechanism configured to prevent the outer shell 150 from inadvertently rotating relative to the inner sleeve 110 due to vibration, for example. The outer shell 150 includes a combination detent tip 170 and release tab 172, while the sleeve wall 112 includes a first recess referred to as a release pocket 136, a second recess referred to as a tensioning pocket 138, and an aperture alignment ramp 137 therebetween. The detent tip 170 is biased radially inward, causing it to reside in one of the pockets 136, 137 138.

The end of the detent tip 170 includes a ramp that enables the detent tip to rotate clockwise with respect to the pockets 136, 137, 138. Detent tip 170 can easily slide up and out of the release pocket 136, which enables the outer shell 150 to rotate clockwise with respect to the inner shell 110. Similarly, the ramp on the right side permits the detent tip 170 to easily slide up and out of the alignment ramp 137, which enables the outer shell 150 to rotate clockwise with respect to the inner shell 110 until the detent tip 170 rotates into the tensioning pocket 138.

The ramp at the tip of the detent tip 170 includes a vertical face on the left side of the detent. That vertical face enables the detent tip 170 to rotate clockwise with respect to the pockets 136, 137, 138, while preventing the detent tip 170 from rotating counter-clockwise with respect to the tensioning pocket 138. As such, the detent tip 170 can catch and lock the detent in tensioning pocket 138, thus locking the outer shell to the inner sleeve. This configuration can, therefore, function as a ratchet system permitting movement in one direction only.

The detent tip 170 and release tab 172 are rigidly connected to one another, while the combination of the detent tip and release tab are flexibly attached to the outer wall 152 of the outer shell 150. This enables the user to press the release tab 172 to lift the detent tip 170 out of the tensioning pocket 138, which allows the outer shell 150 to rotate counter-clockwise with respect to the inner sleeve 110.

To install the first embodiment of the LR fastener 100 to a bolt with a workpiece, for example, the user need only perform the following steps: first the user aligns the outer shell 150 with the inner sleeve 110 such that the primary pawls 114 coincide with the shell apertures 154. This configures the fastener 100 for the linear mode. The user then slides the fastener 100 onto the bolt in a continuous motion in which the fastener moves linearly only. In the process, the primary pawls 114 slide over the threads of the bolt. This motion continues until the face of the sleeve flange 130 abuts the workpiece.

Next, to tension the fastener 100 against the workpiece, the user applies a torque to turn the outer shell 150 in the clockwise direction. Due to the friction between (a) the sleeve flange 130 and the workpiece, (b) the gripping tabs 132, and (c) the primary pawls 114 and the bolt, the torque effectively turns the outer shell 150 relative to the inner shell 110. In doing so, the shell apertures 154 in the outer shell 150 rotate away from the pawls 114, causing the shell wall 152 of the outer shell to occupy the region coinciding with the pawls. As the rotation continues, (a) the tensioning stop wall 162 abuts the stop lug 134, and (b) the detent tip 170 falls into the tensioning pocket 138.

At this point, the primary pawls 114 are locked against the threads of the bolt and the fastener 100 is configured in the rotational mode of operation. In this mode, the outer shell 150 and inner sleeve 110 must rotate in unison with the pawl teeth 120 seated in the threads of the bolt. As the user continues to apply force to the tension wings 156, the fastener 100 is effectively threaded onto the bolt and the fastener 100 tightened against the workpiece. Since the outer shell 150 is locked in place by the detent tip 170 due to the ratchet mechanism, the fastener 100 will remain pressed against the workpiece even if the fastener experiences vibration.

When operated in the linear mode described above, the spring force (directed radial inward) exerted by the primary pawl flexure joints 118 assure that the pawl teeth 120 are properly seated within the threads of the bolt each time those pawl teeth skip over a thread peak of the bolt. On the rare occasion that the pawl teeth 120 fail to properly seat within the threads of the bolt, a misalignment can result in a tooth-to-tooth condition. Using the present invention, however, rotation of the outer shell 150 can quickly remedy the situation. In this situation the primary pawls 114 are deflected outward into the space provided by the shell apertures 154. Consequently, rotation of the outer shell will cause aperture 154 edges to contact the protruding pawls 114 thereby causing the inner sleeve 110 to rotate. This rotation of the inner sleeve 110 around the bolt causes the pawl teeth 120 to eventually align with the bolt threads thereby returning them to their undeflected position, thus allowing the shell wall 152 of the shell 150 to cover the pawls 114.

To release the fastener 100, the user simultaneously: (1) presses the release tab 172 to lift the detent tip 170 out of the release pocket 138, and (2) applies a torque to turn the outer shell 150 in a counter-clockwise manner. Because of the friction between the inner sleeve 110 and the workpiece, the torque applied by the user effectively turns the outer shell 150 counter-clockwise with respect to the inner sleeve 110. As the outer shell 150 turns, the shell apertures 154 rotate into a position over and coinciding with the pawls 114. When this occurs the pawls 114 are released and free to rotate away from the bolt, thus configuring the fastener for the linear mode. The user can then pull the fastener 100 off the bolt in a linear manner, which causes the pawls 114 to skip over the threads of the bolt. As such, the entire removal operation is extremely quick and convenient.

### Second Embodiment

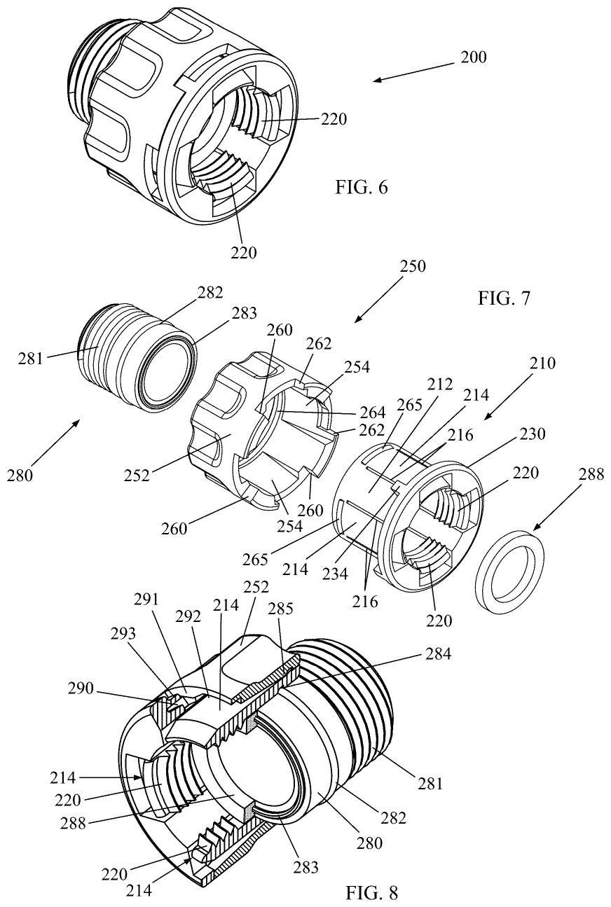

The second embodiment of the LR fastener is illustrated in FIGS. 6-8. The second embodiment of the LR fastener 200 is configured to quickly couple a garden hose or pipe to another hose, hose bibb, or pipe, for example. The second embodiment of the LR fastener 200 operates on the same principles as those of the first preferred embodiment with minor modification described in detail below.

Like the first embodiment, the second embodiment of the LR fastener 200 comprises two concentric cylinders, namely an inner sleeve 210 and an outer shell 250. The inner sleeve 210 includes a plurality of primary pawls 214 while the outer shell 250 includes a plurality of internal apertures or recesses 254 configured to accommodate the primary pawls 214 when they are deflected outward. The internal recesses 254, therefore, permit the primary pawls 214 to flex outward when the fastener is configured in the linear mode, as described below.

In addition to the inner sleeve 210 and an outer shell 250, the second embodiment further includes a hose adapter 280 and a rubber gasket 288. On one end, the hose adapter 280 includes a threaded portion 281 configured to connected to the female end of a first hose (not shown). On the other end, the hose adapter 280 and rubber gasket 288 stack together longitudinally within the inner sleeve 210 to form a seal against the male end of a second hose or hose bibb (not shown). This end of the hose adapter 280 includes a raised annular ring 283 which, when tightened, causes the annular ring to press into the rubber gasket 288 to provide a water-tight seal. When the second hose or hose bibb is captured by and tightened against the fastener 200, water or other fluid passes directly through the hose adapter/rubber gasket without contacting interior components of the inner sleeve 210 or outer shell 250, thus preventing any exposure to corrosion or hard water deposits that could degrade its operation.

The inner sleeve 210 includes a plurality of primary pawls 214 integrally formed from the sleeve wall 212 of the inner sleeve 210. Each of the pawls 214 is a tab with a generally rectangular shape. Each of the pawls 214 is separated from the sleeve wall 212 by a gap 216 on three sides of the rectangle and attached on the fourth side. The length and thickness of the fourth side is configured to enable each primary pawl 214 to flex with respect to the sleeve wall 212, thereby serving as a hinge or flexure joint or separate hinge. In some embodiments, the primary pawls 214 can flex up to approximately 5-10 outward with respect to the inner sleeve 210 without damage. Each of the four primary pawls 214 further includes helical threads 220 with a profile matching that of the hose thread.

In the second embodiment, the sleeve wall 212 of the inner sleeve 210 includes a segmented snap ring 265 configured to seat within an annular channel 264 on the inner surface of the outer shell 250. Together, the segmented snap ring 265 and annular channel 264 provide a friction fit that holds the inner sleeve and outer shell in longitudinal alignment while still enabling the two components to rotate relative to one another. Similarly, the outer surface of the hose adaptor 280 includes a snap ring 282 configured to seat within an annular channel 284 on the inner surface of the inner sleeve 210. Together, the snap ring 282 and annular channel 284 provide a friction fit that holds the inner sleeve 210 and hose adaptor 280 in longitudinal alignment while still enabling them to rotate relative to one another.

When the inner sleeve 210 and outer shell 250 are attached to one another, the four primary pawls 214 of the inner sleeve generally align/coincide with one of two different structures in the outer shell. In the linear mode, each of the primary pawls 214 radially coincides with one of the shell recesses 254. This enables the four pawls 214 to flex radially outward, thereby permitting the pawls to slide over the threads of the hose. In the radial mode, each of the pawls 214 coincides with a portion 285 of the outer shell 250 without a recesses 254, which prevents the pawls from flexing outward away from the threads of the hose.

The inner sleeve 210 further includes a sleeve flange 230 integrally formed with the inner sleeve 210. The sleeve flange 230 projects radially outward from one end of the sleeve wall 212. The end of the inner sleeve with the sleeve flange 230 is referred to herein as the “bibb end” since it abuts, secures, or otherwise captures the threaded male portion of the hose or bibb. In the second preferred embodiment, the overall diameter of the sleeve flange 230 is approximately equal to the diameter of the outer shell 250.

In the second preferred embodiment, the sleeve flange 230 includes at least one stop lug 234 that projects longitudinally from the sleeve flange in the direction opposite from the bibb end. The outer sleeve 250 includes at least one tensioning stop wall 262 and at least one release stop wall 260. When the user rotates the outer shell 250 in a clockwise direction relative to the inner sleeve 210, for example, the tensioning stop wall 262 incorporated into the outer shell turns until it abuts the stop lug 234. When the user rotates the outer shell 250 in a counter-clockwise direction relative to the inner sleeve 210, for example, the release stop wall 260 incorporated into the outer shell turns until it abuts a stop lug 234. Thus, the outer shell can rotate with respect to the inner sleeve to the extent that the stop lug 234 can rotate between the tensioning stop wall 262 and release stop wall 260. The relative rotation is on the order of about 60 degrees (between 40 degrees and 115 degrees).

Illustrated in FIG. 8 is an oblique partially-sectioned view providing an alternate view of the same elements described above plus the shell alignment system comprising a flexible alignment tongue 290, an alignment ramp 291, and an open alignment pocket 292, and closed alignment pocket 293. The purpose of the shell alignment system is to assure that the outer shell 250 remains in the proper alignment with respect to the inner sleeve 210 for insertion and for extraction of a hose or hose bibb, for example.

To use the LR fastener 200 to couple a hose to a bibb (not shown), for example, the female end of the hose is first screwed onto the threaded end 281 of the hose adapter 280. Next, the fastener 200 is attached to the male threads of the hose bibb. To do so, the internal recesses 254 in the outer shell 250 are initially aligned directly above the primary pawls 214, thereby allowing the pawls freedom to flex outward. This is accomplished by rotating the outer shell 250 counter-clockwise until the flexible alignment tongue 290 is situated in the open alignment pocket 292 of the alignment ramp 291. This configures the fastener 200 in the linear mode of operation.

Once in this linear mode, the primary pawl 214 teeth can freely skip over the male threads of the hose bibb until it makes contact against the rubber washer/gasket 288. As described above, this design eliminates the possibility of cross threading.

At this point, the fastener 200 must be configured in the rotational mode with the primary pawl threads 220 engaging the threads of the hose bibb. To do so, the user need only rotate the outer shell 250 clockwise, which causes the tensioning stop wall 262 to contact the stop lug 234 thereby moving the inner shell recesses 354 to a position out of alignment with the primary pawls. Placing the solid portion 285 of the outer shell 250 over the pawls 214 assures that the pawls remain engaged with the male threads of the hose bibb. This clockwise rotation of the outer shell 250 also causes the alignment tongue 290 to traverse the alignment ramp 291 and settle in the closed pocket 292 where it secures the adapter 280 from inadvertently releasing the closure. Since the teeth of the primary pawls are now engaged with the hose bibb, further clockwise rotation of the outer shell 250 serves to tighten the connection between the fastener and the hose bibb. This process also compresses the rubber gasket 288 between the fastener 200 and the bibb.

Removal of the fastener is accomplished by rotating the outer shell 250 counter-clockwise until contact between the release stop walls 260 and the stop lugs 234 re-aligns the shell recesses 254 with the primary pawls 214 so that the pawls are free to flex outward. The fastener can then be removed directly without further rotation.

### Third Embodiment

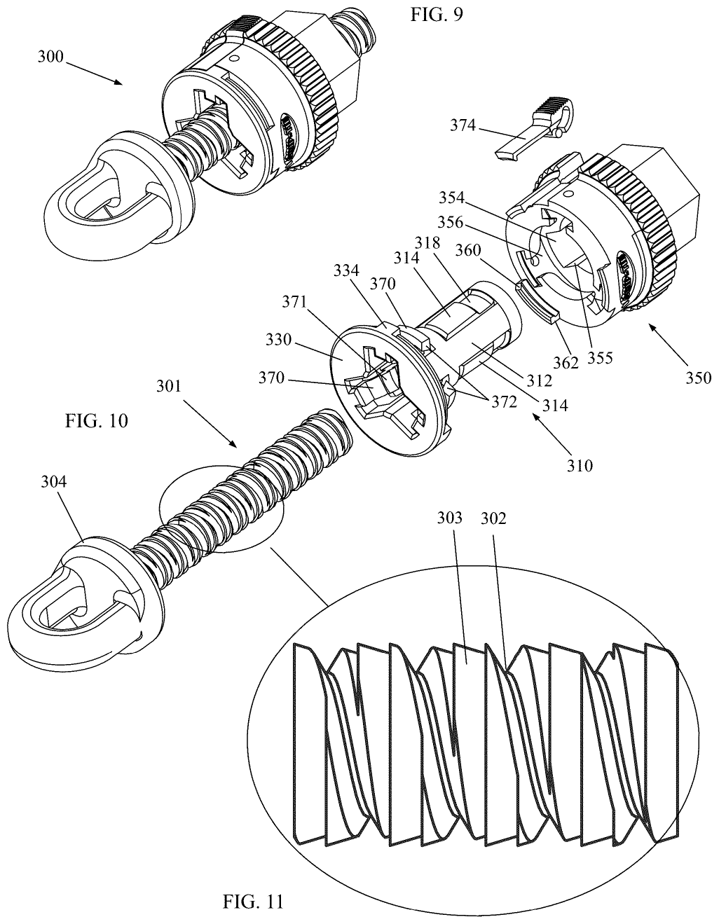

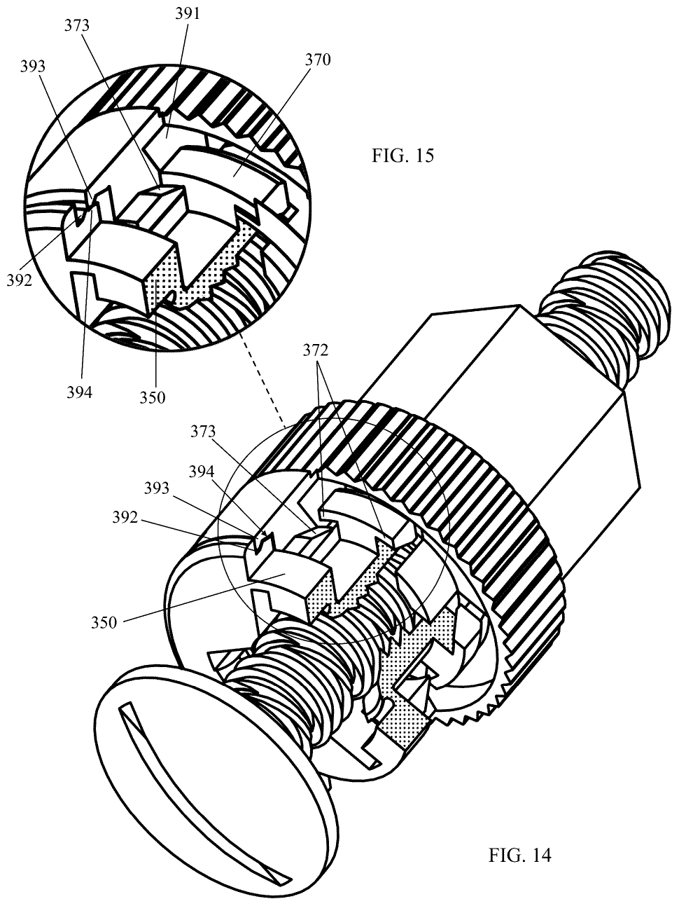

Illustrated in FIGS. 9-14 is an LR fastener system in accordance with a third preferred embodiment of the present invention. The fastener system 300 comprises a specialty bolt and a compatible fastener. The specialty bolt—referred to herein as a dual-thread bolt 301—includes a first set of threads interleaved or otherwise interposed longitudinally with a second set of threads. The first set of threads consist of standard helical threads 302 as described herein. In profile, the standard threads resemble teeth having a triangular shape with symmetric sloping sides. The second set of threads, in contrast, consist of sawtooth-shaped threads with ratchet-shaped teeth. In profile, “sawtooth” and “ratchet” threads resemble a right-triangle with one vertical edge that is perpendicular to the longitudinal bolt axis and one sloped edge on the opposite side. The ratchet threads are employed to enable the bolt 301 to slide onto the fastener in one direction, but inhibit the bolt from sliding off the fastener in the opposite direction.

In this preferred embodiment, the ratchet threads comprise a plurality of annular rings 303 spaced at regular intervals longitudinally along the length of the bolt 301. In cross section, these annular rings 303 serve the same purpose as the teeth of a conventional cable tie, for example. That is, each of the annular rings 303 possesses a vertical face on one side of the annular ring 303, and a sloping face on the other side of the annular ring. The vertical face on one side of the annular ring 303 is configured to latch onto a vertical face of a structure in the fastener 300, while the sloping face on the other side of the annular ring is configured to slide past another sloping face of a structure in the fastener. Thus, the bolt 301 is able to easily move in one direction with respect to the fastener, while movement in the other direction is inhibited. In this preferred embodiment, the vertical face of the annular rings 303 are oriented toward the head 304 of the bolt 301, while the sloping face of the annular rings are oriented toward the tail end of the bolt. As such, the fastener readily slides onto the dual-thread bolt, while being difficult to slide off of the dual-thread bolt.

The ratchet threads 303 and helical threads 302 are interleaved with one another. At the boundary, the two thread patterns intersect and blend into one another, which occurs every few millimeters for the length of the bolt. The advantage of this particular dual-thread design is that the fastener can be placed on the bolt and advanced over the bolt threads by linear insertion without the need of rotation. When the fastener is abutting the workpiece mounted on the bolt 301, rotation of the fastener may then be employed to advance the fastener along the helical threads 302 toward the head 304 of the bolt, thereby tensioning the workpiece in place.

The fastener in this embodiment comprises concentric cylinders including an inner sleeve 310 and an outer shell 350. The inner sleeve 310 comprises a plurality of primary pawls 314 and a plurality of secondary pawls 370. The plurality of primary pawls 314 includes three pawls distributed uniformly around the inner circumference of the inner sleeve 312. Each of the primary pawls 314 is generally rectangular in shape and is attached to the inner sleeve 312 by means of a hinge or flexure joint 318. On the inside face of each primary pawl is a helical thread segment 320 configured to seat with the helical threads 302 of the dual-thread bolt 301. The helical threads 320 of the primary pawl 314 are on the end of the pawl opposite the flexure joint 318. Although the helical threads 320 of the primary pawl 314 are biased toward the bolt 301, the helical threads can be pulled away or lifted off of the threads of the bolt.

The outer shell 350 of the fastener includes a plurality of recesses 354, each recess having a location corresponding to one of the primary pawls 314. The size and shape of each of the recesses 354 is designed to accommodate a primary pawl 314 when it rotates radially outward and away from the bolt 301. When the fastener 300 is in the linear mode, the dual-thread bolt 301 can be inserted into the inner sleeve 310 which causes the primary pawls 314 to lift away (i.e., deflect) from the bolt and into a recess 354 of the outer shell. As such, the fastener can easily slide onto the bolt and toward the head of the bolt without rotation of the fastener.

In addition, the fastener 300 is configured to operate in a rotational mode in which the recesses 354 are rotated clockwise away from the primary pawls 314 and a solid section 312 of the outer shell 350 rotated to a position radially aligned with the primary pawls. In the absence of the recesses 354, the primary pawls 314 are blocked from flexing outward by the outer shell, thus retaining the pawl teeth 320 against the helical bolt threads 302. Further rotation of the outer shell 350 relative to the inner sleeve 310 then causes the shell to advance along the helical bolt threads 302, thereby tightening against a workpiece between the fastener and bolt head 304.

In this embodiment, the inner sleeve 310 and outer shell 350 are detachably attached using a friction fit that includes a shell/sleeve snap joint. This snap joint includes an annular groove 392 formed on the surface of the annular flange 330 of the inner sleeve 310. A matching ring 393 is formed on the outer shell 310 where it abuts the flange. The snap joint is configured to provide the friction needed to hold the inner sleeve 310 and outer shell 350 together until manually detached by the user. With one or two pounds of force, the user can overcome the friction and separate the outer shell 350 from the inner sleeve 310.

The flange 330 of the inner sleeve further includes a stop lug 334 to limit the rotation of the outer shell to almost 60 degrees relative to the inner sleeve. In the linear mode, the stop lug 334 abuts a release stop wall 360. When the outer shell is rotated, however, the stop lug 334 abuts a tensioning stop wall 362.

The inner sleeve 310 further includes a plurality of secondary pawls 370 distributed uniformly around the periphery of the sleeve. The secondary pawls 370 include ratchet teeth 371 configured to engage the annular rings 303 on the bolt 301. When the dual-thread bolt 301 is inserted onto the fastener, the secondary pawls 370 are configured slide over both the helical threads 302 as well as the ratchet threads 303 of the dual-thread bolt. In the process, the secondary pawls 370 flex radially outward into the secondary pawl cavity 356 formed in the outer shell. The secondary pawl cavity 356 is an annular cavity spanning 360 degrees around the inner surface of the outer shell 350, which permits the secondary pawls 370 to deflect outward regardless of the circumferential position of the outer shell.

While the secondary pawls 370 are configured slide over both the helical threads 302 and ratchet threads 303 in the direction of the bolt head 304, the ratchet threads 371 of the secondary pawls 370 are configured to “latch” onto the face of an annular ring 303 and prevent the fastener 300 from sliding in the direction away from the bolt head 304. This serves two distinct functions. The first function is to interlock the inner sleeve 310 and the bolt 301 such that the bolt cannot be retracted even if the helical threads 302 have not been engaged by the primary pawls 314. In this mode, the fastener acts as a “set it and forget it” fastener where the bolt 301 is simply inserted directly into the fastener with no need to tighten the closure. The second function is to act as a safety device to prevent the fastener from inadvertently sliding off the bolt if the primary pawls 314 were to disengage the helical threads of the bolt.

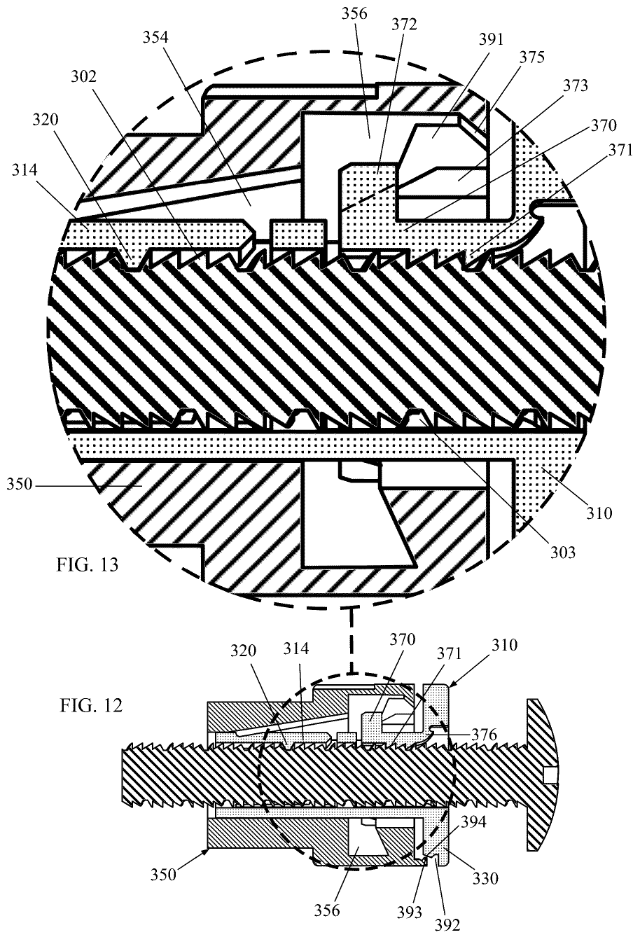

FIGS. 12 and 13 illustrate the configuration of the secondary pawls 370. The secondary pawls 370 are integrally connected to the inner sleeve 310 by means of a hinge or flexure joint 376. Each of the secondary pawls includes threads 371 with a sawtooth-shaped profile. The sawtooth-shaped threads 371 are characterized by a sloping face on the side of the thread facing the head 304 of the bolt 301, and a vertical face on the side facing the tail end of the bolt. When a dual-thread bolt 301 is inserted into the fastener, the sloping face on the side facing the head effectively skips over the sloping face of the annular rings 303 on the dual-thread bolt. In contrast, the vertical face of the sawtooth-shaped threads are configured to catch the vertical face of the annular rings 303 of the dual-thread bolt 301, thereby holding the components together like a ratchet device.

Once the dual-thread bolt 301 has been inserted into the fastener, the bolt cannot be easily removed from the fastener. There is, however, a mechanism to disengage the secondary pawls 370 from the dual-thread bold in order to remove the bolt 301 from the fastener, as explained in more detail below.

The third embodiment of the fastener has two basic operational configurations: (a) “the set it and forget it” mode and (b) the “tensioning” mode. In the “set it and forget it” configuration illustrated in FIGS. 9 and 10, the outer shell snap ring 393 is captured by the inner sleeve snap groove 392. This enables the dual-thread bolt 301 to be inserted in the fastener to the desired position. When the desired position is reached, the secondary pawl teeth 371 settle into engagement with an annular ring 303 of the dual-thread bolt. In this “set it and forget it” mode, the fastener is operational from the start and the bolt secured in the fastener until released by the user.

In the second operational configuration, i.e., the tensioning mode, the fastener is configured to thread onto the dual-thread bolt 301 and tighten against a workpiece captured therebetween with the cooperation with the primary pawls 314. In this configuration, the outer shell 350 is rotated clockwise relative to the inner sleeve 310 until the cavity wall 355 comes into contact with the primary pawls 314 which, at this time, are deflected outward. Further rotation moves both the outer shell 350 and the inner sleeve 310 together until the primary pawl teeth 320 and the bolt's helical threads 302 are in alignment. At this point, the primary pawl teeth 320 drop into engagement with the helical bolt threads 302, thereby clearing the way for the outer shell 350 to rotate freely about the inner sleeve 310 until the primary pawls 314 are covered by the solid portion 312 of the outer shell. This covering prevents the primary pawls 314 from deflecting outward, thereby ensuring that the primary pawl teeth 320 remain engaged with the bolt threads. Simultaneously, the tensioning stop walls 362 (as seen in FIG. 10) on the outer shell 350 come into contact with the stop lugs 334 (as seen in FIG. 10) on the inner sleeve 310, thereby allowing the inner sleeve and outer shell to rotate together. Further clockwise rotation of the outer shell then causes the fastener to move toward the head 304 of the bolt, thereby tensioning the fastener against the workpiece being captured by the fastener.

In this embodiment, the secondary pawls 370 include a T-shaped pawl appendage with a horizontal wing section 372, although other shapes and configurations are contemplated. The secondary pawls are laterally confined between a pair of pawl cavity walls 355 which are integral with the outer shell 350. The secondary pawl ramps 373 are configured to lift the secondary pawls 370 away from the bolt based on the movement of the outer shell by wedging the secondary pawl ramps 373 under the horizontal wing section 372.

Removal of the fastener while in the “tensioning mode” it is essentially the reverse of the procedure described in the tensioning mode. First, the user grasps the outer shell 350 of the fastener and rotates it counter-clockwise until the extraction stop walls 360 on the outer shell 350 come into contact with the stop lugs 334 on the inner sleeve 310. This results in the positioning of the secondary pawl ramps 373 and secondary pawl wing cavity 391 directly in line with the secondary pawls 370. Next, the user retracts the outer shell 350 axially away from the bolt head 304. Because the secondary pawl teeth 371 are still engaged with the ratchet teeth 303 on the bolt 301, it is possible for the outer shell 350 to retract without any rotational movement of the inner sleeve 310. This retraction of the shell causes the shell/sleeve snap joint 392, 393 to disengage.

Further retraction of the outer shell 350 causes the secondary pawl wings 372 to engage with the pawl ramps 373, thus imposing a lifting force on the wing section 372 of the secondary pawls 370. Continued retraction of the outer shell 350 causes the secondary pawls 372 to be elevated radially outward into the secondary pawl wing cavities 391 in the outer shell 350. The pawl wings 372 are prevented from overshooting the ramps by the wing stop wall 375. As the secondary pawls 370 move radially outward, the pawl teeth 371 disengage with the bolt's annular ring 303 thereby allowing the fastener to be extracted from the bolt 501.

Once the fastener has been removed from the bolt 301, there is no longer any force retaining the secondary pawls 370 in an elevated condition. Consequently, the residual torque residing in the deflected secondary pawl arms causes the pawls 370 to reverse direction, thus leaving them in a cocked position and ready for insertion. This causes the inner sleeve 310 to retract toward the outer shell 350 until the sleeve portion of the snap ring joint 392 comes into contact with the shell portion 393. The inner sleeve portion of the snap ring joint 392, 393 features an inclined face 394 which presents a resistance to the joint re-engaging. This resistance increases as the shell portion 393 of the snap ring joint ascends the inclined face 394. The residual torque in the deflected pawl arms is limited and is insufficient to enable the outer shell 350 to surmount the inclined snap ring face 394. Therefore, as seen in FIG. 15, the inner sleeve 310 becomes suspended in limbo between the spring force and the incline resistance. This presents an ideal condition for the separated fastener since it is now ready for re-installation on the bolt. With the pawls in their resting position, the outer shell 350 is unable to rotate due to lateral constraints presented by the secondary pawl wing cavity 391 and the fastener will remain ready for reuse.

Removing the fastener while in the “set it and forget it” mode requires one less step than the procedure described above. Since the fastener has not been tensioned, the secondary pawls remain uncovered, thereby allowing the secondary pawls to freely flex outward. Consequently, rotating the outer shell is unnecessary. As such, retraction of the outer shell is all that is necessary to release the secondary pawls from the bolt, thereby allowing the fastener to be readily removed from the bolt.

Some versions of the third embodiment of the fastener include an additional security feature, namely a release lever 374 configured to snap into place on the outer shell 350. This release lever 374 employs a hook at one end and a flexible recurve portion which serves as a spring. The lever 374 pivots around the lateral pins which are provided to snap into the outer shell 350. When the fastener and bolt are fully engaged, the hook end of the lever 350 is engaged with the circular face of the flange 330 of the inner sleeve 310 and is held in engagement by the recurve flexible spring at the opposite end. In this manner, the fastener and bolt are prevented from inadvertent separation under any circumstances. When it is necessary to separate the fastener and bolt, the user need only depress the spring end of the lever, thereby lifting the hook and releasing the inner sleeve.

### Fourth Embodiment

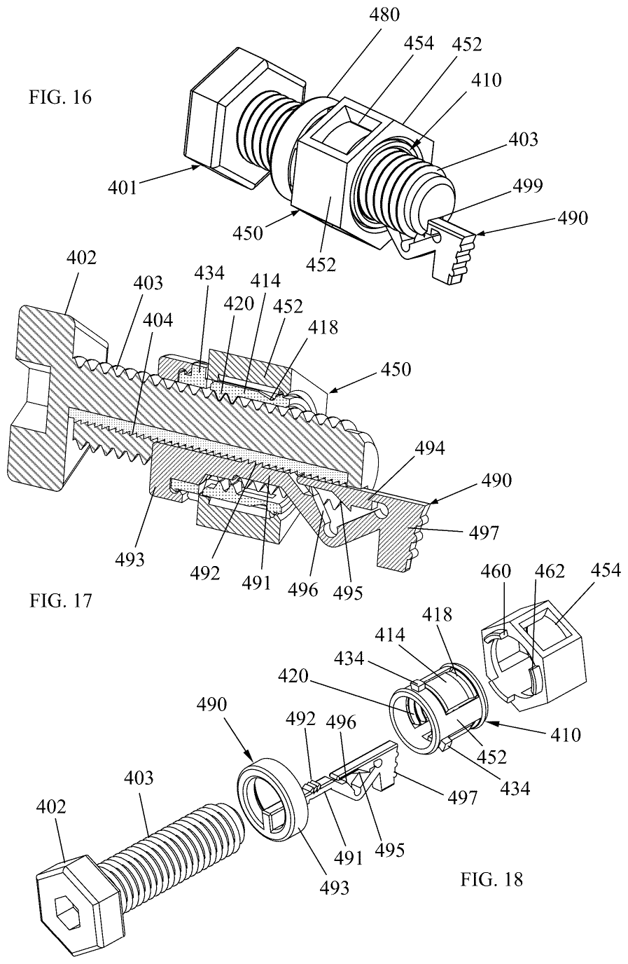

The fourth embodiment of the fastener is illustrated in detail in FIGS. 16-18. The fourth preferred embodiment generally comprises a four-piece fastener that provides the function of a conventional nut-and-bolt fastening system while providing additional benefits described below.

The fastener system comprises a dual-thread bolt 401 and corresponding fastener. The bolt 401 includes (1) a head 402, (2) a first set of helical threads 403 running the length of the bolt, and (3) a second set of ratchet threads/teeth 404 recessed in a longitudinal channel 499 running the length of the helical threads. In profile, the ratchet threads are characterized by ratchet teeth 404, each tooth having a vertical face oriented toward the dual-thread bolt head 402 and a sloped face oriented opposite the head of the bolt. The vertical face of each tooth 404 is substantially perpendicular to the longitudinal axis of the dual-thread bolt. The ratchet teeth 404, together with a secondary pawl 491, provide a fail-safe closure. If desired, the secondary pawl 491 can be removed by releasing the pawl 491 from the ratchet teeth 404 of the longitudinal channel.

The fastener 400 in this embodiment comprises an inner sleeve 410, an outer shell 450, and release pawl device 490. The inner sleeve 410 features a plurality of primary pawls 414 integrally formed with the inner sleeve 410. The three primary pawls 414 are preferably spaced equidistant around the circumference of the inner sleeve 410. Each of the primary pawls 414 employs a series of helical thread segments 420 configured to engage the helical threads 403 of the dual-thread bolt 401. The primary pawls 414 include a hinge or flexure joint 418 that enable the primary pawls to flex radially outward. The outer shell 40 then includes a plurality of rectangular apertures 454 configured to receive the primary pawls 414 when they rotate away from the bolt 401.

The inner sleeve 450 includes at least one stop lug 434, while the outer shell includes a plurality of rotational stop walls 460 and 462 configured to engage the stop lugs 434. Although the outer shell is configured to rotate relative to the inner sleeve, the angular range is limited by the stop lug 434 and stop walls 460, 462. In this preferred embodiment, the outer shell 450 is configured to rotate approximately 60 degree with respect to the inner sleeve 410. The combination of stop lug 434 and stop walls 460, 462 also serves to accurately position the apertures 454 circumferentially with respect to the primary pawls 414 for either insertion or extraction.

The fastener also includes a secondary pawl device 490 configured to cooperate with a dual-thread bolt 401 to provide a companion catch-and-release security feature. The secondary pawl device 490 comprises a secondary pawl 491, ratchet teeth 492, pawl ring 493, release arm 494, first ramp 495, second ramp 496, and release tab 497.

The pawl ring 493 is configured to capture the dual-thread bolt 401 and situate the secondary pawl 491 within the inner sleeve 410. When situated within the inner sleeve 410, the secondary pawl 491 is aligned parallel with the longitudinal channel 499. In this configuration, the secondary pawl teeth 492 can engage the ratchet threads 404 in the longitudinal channel 499.

The secondary pawl 491 is flexibly attached at one end to the pawl ring 493 in order to enable the secondary pawl teeth 492 to flex relative to the pawl ring. In the preferred embodiment, the secondary pawl 491 causes the secondary pawl teeth 492 to be biased upward so as to provide positive pressure holding the secondary pawl teeth against the ratchet threads 404 of the longitudinal channel 499. The teeth 492 of the secondary pawl 491, like the teeth 404 of the longitudinal channel 499, are configured to function as a ratchet. As such, the secondary pawl 491 is configured to slide over the ratchet teeth 404 of the longitudinal channel 499 when the bolt 401 is inserted into the fastener, but then inhibit the bolt from being removed from the fastener once the secondary pawl 491 has been engaged.

The fourth embodiment of the fastener system can be assembled as follows: First, the fastener together with the secondary pawl device 490 is placed on the end of the dual-thread bolt 401 and is pushed directly along the axis of the bolt until the pawl ring 493 contacts the surface of a workpiece to be secured. During this axial movement, the primary pawls 414 are configured to flex outwardly as they skip over the helical threads 403 of the bolt 401. This movement is made possible due to the disposition of the apertures 454 in the outer shell 450 which are situated directly above the pawls, thereby enabling the primary pawls to flex outward as they skip over the helical threads 403. The spring force of the primary pawls 414, which are biased radially inward by the pawl flexure joints 418, assures that the pawl teeth 420 re-engagement with the bolt helical threads 403 after surmounting each thread peak. Finally, the fastener is rotated clockwise until the solid segments 452 between the shell apertures 454 are rotated into position directly above the primary pawls 414, thereby preventing the pawls from lifting and disengaging from the bolt threads. Precise registration of the outer shell solid segments 452 is assured by virtue of the contact between the tensioning stop walls 462 on the outer shell 450 and the stop lugs 434 on the inner sleeve 410. Upon further rotation of the outer shell 450, the contact between the stop walls 460 and the stop lugs 434 causes the inner sleeve 410 to be driven rotationally by the outer shell 450. The primary pawl teeth 420 are then engaged with the bolt threads 403, causing the inner sleeve 410 and thus the secondary pawl 490 to move further against the workpiece.

The present design prevents the primary pawl threads 420 and the helical threads 403 of the bolt 401 from becoming misaligned in a tooth-to-tooth scenario. In this situation, the primary pawls 414 are deflected radially outward into the space provided by the apertures 454. Consequently, rotation of the outer shell 450 causes edges of the aperture 454 to contact the protruding pawls 414, thereby causing the inner sleeve 410 to rotate with outer shell 450. This rotation of the inner sleeve 410 around the bolt 401 causes the primary pawl teeth 420 to eventually align with the bolt threads 403, thereby returning them to their undeflected position and alleviating the tooth-on-tooth scenario. The primary pawl threads 420, which are now engaged with the bolt threads 403, perform the same function as the internal screw threads in a conventional nut, thereby causing the fastener to move toward the bolt head.

The fourth embodiment of the fastener system 400 can be released as follows: At the distal end of the secondary pawl device 490, opposite the pawl ring 493, is a release tab 497 for releasing the bolt 401 from the fastener. To start, the user disengages the secondary pawl by pressing the release tab 497 in the direction of the bolt head 402, which causes the V-shaped structure to flex in a manner such that the release arm 494 is displaced inward until ramp 495 contacts ramp 496. With further movement inward, these opposing ramp slopes cause the release arm 494 to act as a wedge disengaging the secondary pawl teeth 492 from the secondary bolt teeth 404. At this point, the release arm 494 drops downward causing lateral ramps 495 and 496 to engage with each other, thereby locking the release in the open position to facilitate removal of the bolt 401. When the bolt 401 is removed, the pawl arm 491 is no longer confined by the bolt longitudinal channel and the opposing lateral ramp slopes, together with the outward spring force created by the distortion of the V-shaped structure, cause the secondary pawl 491 to be flexed sideways. This causes the lateral ramps 495, 496 to disengage and the secondary pawl 491 to return to the unlocked position.

The user then rotates the outer shell 450 counter-clockwise until the release stop wall 460 on the outer shell comes into contact with inner sleeve stop lug 434, at which point the apertures 454 are once again situated directly above the primary pawls 414, making it ready for extraction. The primary pawls 414 are then free to skip over the bolt threads 403 as the fastener is withdrawn linearly from the bolt.

The fourth embodiment of the fastener system described herein thus provides a quick install and release device that is tensionable and completely secure.

### Fifth Embodiment

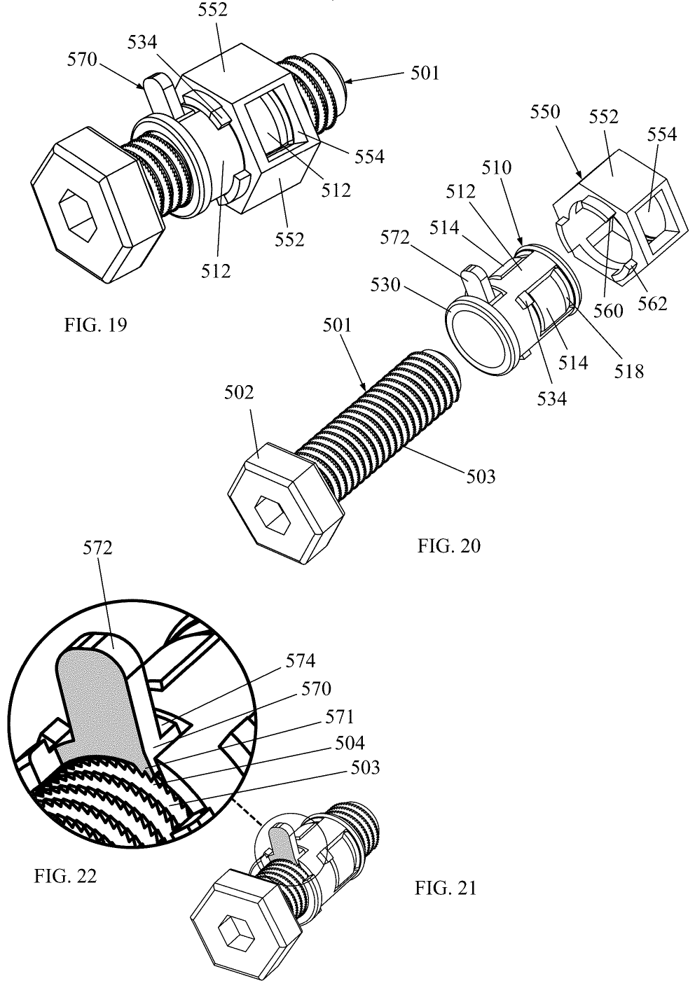

The fifth embodiment of the present invention is illustrated in FIGS. 19-22. The fifth embodiment of the LR fastener system comprises a dual-thread bolt 501 and compatible fastener which includes an inner sleeve 510 and outer shell 550. Together, the dual-thread bolt 501 and compatible fastener cooperate to provide an attachment system with a linear mode for fast installation and a rotational mode for tensioning the fastener against a workpiece.

In this embodiment, the dual-thread bolt 501 includes a head 502 and a threaded rod portion. The threaded rod portion includes helical threads 503 with integral ratchet teeth 504. The helical threads 503 are conventional to the extent they are characterized by a pitch, a pitch diameter, and the number of threads per unit length, as defined by the standards described herein. The helical threads 503 deviate from convention to the extent that they further include ratchet teeth 504 formed linearly along the circumference of the helical threads. As shown in FIG. 22, the ratchet teeth 504 are cut into the crest, i.e., the outer diameter, of the conventional helical threads 503. The ratchet teeth 504 are characterized by a profile having a vertical face on one side and a sloped face on the other side, where the profile runs parallel with the crest of the helical thread 503. The vertical face is configured to catch the secondary pawl described in more detail below.

The inner sleeve 510 of the fastener component is provided with a plurality of primary pawls 514 integrally connected to the body 512 of the inner sleeve 510 by means of a hinge or flexure joint 518. Each of the primary pawls 514 includes a helical thread pattern on the end of the pawl 514 opposite the flexure joint 518. The helical thread pattern is configured to match the helical thread pattern 503 of the dual-thread bolt 501. The three primary pawls 514 are biased inward toward the bolt 501, but can flex outwardly about the flexure joint 518 during insertion or removal of the bolt. The outer shell 550 includes primary pawl apertures 554 that accommodate the primary pawls 514 when they pivot outwardly, which corresponds to the linear mode of operation.

The inner sleeve 510 further includes a plurality of stop lugs 534 configured to limit the rotation of the outer shell 550. The outer shell 550, in contrast, includes a plurality of release stop walls 560 and a plurality of tensioning stop walls 562. When the three release stop walls 560 abut the three stop lugs 434, the three primary pawl apertures 554 align with the three primary pawls 514. In this configuration, referred to herein as the linear mode, the primary pawls 514 are able to skip over the helical threads 503 of the dual-thread bolt 501. When the outer shell 550 is rotated and the three tensioning stop walls 562 abut the three stop lugs 534, the three primary pawls 514 are covered by a solid portion 512 of the outer shell 550, thus preventing the primary pawls from skipping over the helical threads. In this configuration, referred to herein as the rotational mode, the primary pawls 514 are locked against the helical threads 503 of the dual-thread bolt 501 so that the fastener may be tensioned against a workpiece.

The inner sleeve 510 further includes at least one secondary pawl 570. The secondary pawl 570 includes ratchet teeth 571 configured to “catch” or otherwise engage the ratchet teeth 504 of the dual-thread bolt 501 as the outer shell 550 is rotated around the inner sleeve 510. In the preferred embodiment, the secondary pawl 570 includes a thumb tab 572 and a flexure joint 574 integrally connecting the second pawl to the inner sleeve 510.

To secure the fastener and dual-thread bolt 501 together, the user rotates the outer shell 550 counter-clockwise until the release stop wall 560 contacts the stop lug 534. This rotation moves the pawl apertures 554 to a position directly above the primary pawls 514. The fastener can then be pushed directly onto the bolt 501, without rotation, until it abuts a workpiece, for example. As the fastener moves inward toward the workpiece, the primary pawls 514 repeatedly skip over the bolt threads 503. The outward deflection of the primary pawls 514 lifts the pawls into the pawl apertures 554. Concurrently, the secondary pawl 570 is laterally engaging and disengaging with the ratchet teeth 504 of the bolt 501 in a sequential manner. In the event that the primary pawl teeth and the helical threads 503 are not in alignment for engagement, the edges of the secondary pawl teeth 571 are chamfered so that they can overcome the ratchet teeth 504.

When the flange 530 of the inner sleeve 510 comes into contact with the workpiece, the fastener may be tensioned against the workpiece by rotating the outer shell 550 clockwise until the tensioning stop wall 562 comes into contact with the stop lug 534. As the user rotates the outer shell 550, the primary pawl apertures 554 rotate away and solid portions 552 of the outer shell rotate into alignment with the primary pawls 514, thus preventing the primary pawls from flexing outward. The primary pawl teeth then engage the helical threads 503 of the bolt 501. Further rotation of the outer shell 550 causes the tensioning stop wall 562 to apply a force against the stop lug 534 which drives the inner shell 510 clockwise to tension the closure. The primary pawl teeth then lock into place. Concurrently, the ratchet teeth 571 of the secondary pawl 570 catch the ratchet teeth 504 of the bolt 501, thereby preventing any inadvertent loosening of the closure.

To release the fastener, the user can release lever 572 by pressing laterally to disengage the secondary pawl 570 from the ratchet teeth 504 of the bolt 501. The user can then rotate the outer shell 550 counter-clockwise until the release stop wall 560 contacts the stop lug 534. At this point, the fastener can be removed directly from the bolt without further rotation.

### Sixth Embodiment

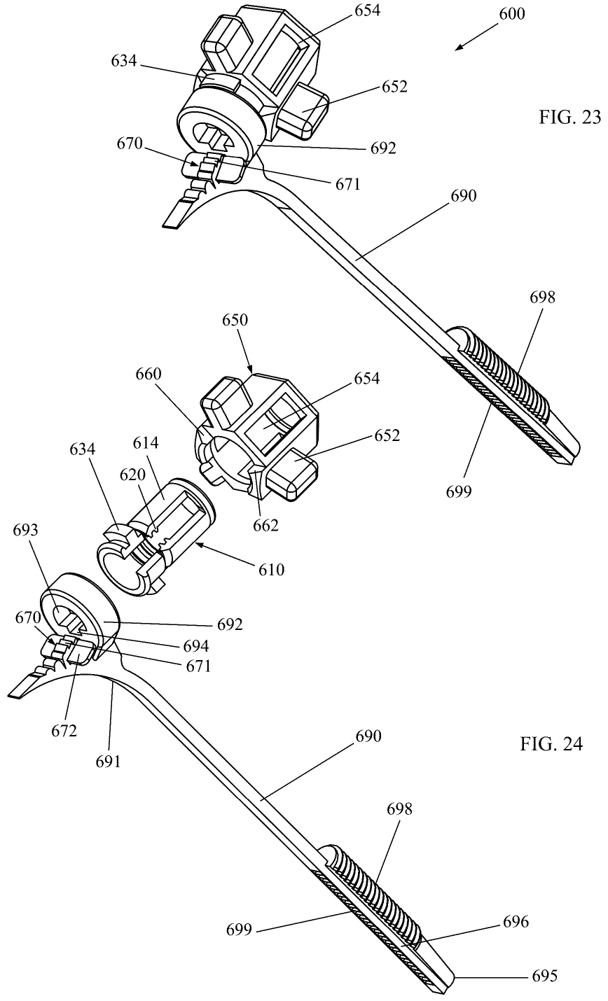

Illustrated in FIGS. 23-24 is a sixth embodiment of a fastener system, in accordance with the present invention. The LR fastener system 600 comprises an elongated strap component 690 and fastener where the fastener comprises an inner sleeve 610 and an outer shell 650. The proximal end 691 of the strap component 690 is attached to an entry ring 692 which, in turn, connects to the fastener. Integrally formed on the distal end 695 of the strap component are a first set of threads and second set of threads. The first set of threads include conventional helical threads 698, while the second set of threads include ratchet-type threads/teeth 699 on the side opposite the helical threads. The distal end 695 of the strap component can then be looped around and inserted into the entry ring 692 of the fastener where it can be attached using a combination of linear and rotational motion.

The strap component 690 is a flexible strip or belt made of elastomeric material. The length of the strap component 690 may vary between several centimeters and several meters. The helical threads 698 and ratchet threads 699 may traverse all or some of the length of the strap component 690. The ratchet threads 699 have a profile characterized by a vertical face on one side of each thread and a sloping face on the opposite side. The slope is generally on the order of 30 degrees.

The inner sleeve 610 includes a plurality of primary pawls 614 uniformly spaces around the circumference of the inner sleeve. There are three primary pawls 614 in the preferred embodiment, each pawl including a segment of helical threads 620 facing radially inward. In the preferred embodiment, the primary pawls 614 are connected to the body of the inner sleeve by means of a hinge or flexure joint (not shown), which enables the primary pawls 614 to pivot radially outward against an inward biasing force. The outer sleeve 650 includes a plurality of primary pawl apertures 654 uniformly distributed around the circumference of the outer sleeve so as to coincide with the primary pawls 614. When the primary pawls 614 are made to flex outward during assembly, the primary pawls swing into the cavity provided by the pawl apertures 654.

The outer shell 650 is configured to rotate relative to the inner sleeve 614. When the outer shell 650 is rotated by the width of a primary pawl 614, the pawl apertures 654 are rotated away from the primary pawls and replaced with a solid section of the outer shell 650. The solid section of the outer shell 650, when aligned with the primary pawls 614, prevents the primary pawls 614 from rotating outward, thus securing them in place. In the preferred embodiment, the inner sleeve includes a stop lug 634, while the outer shell includes a release stop wall 660 and tensioning stop wall 662. The outer shell 650 can be rotated with respect to the inner sleeve 610 to the extent that the stop lug 634 can rotate between a release stop wall 660 and tensioning stop wall 662. In this embodiment, the outer shell includes tensioning wings 652 with which the user can apply the force necessary to rotate the outer shell 650.

To capture a workpiece, the distal end 695 of the strap component 690 can be looped back into the entry ring 692. When inserted, the primary pawls 614 engage the helical screw threads 698 to capture and tension the workpiece. In addition to the primary pawls 614, the fastener system further includes at least one secondary pawl 670 at the entry ring 692. The secondary pawl 670 includes a plurality of ratchet threads 671 configured to engage the ratchet teeth 699 of the strap 690 when inserted into the fastener component. In this embodiment, the distal end 695 of the strap component 690 may engage the secondary pawl 670 before engaging the primary pawls 614. In this embodiment, the second set of ratchet threads 699 are integrally form on the key 696 which, when inserted into keyway 694, prevents the strap component 690 from rotating as it is drawn into the fastener.

To use this fastener system, the distal end 695 of the strap component 690 is wrapped around the circumference of a workpiece and fed through the entry ring aperture 693 and into the inner sleeve 610. Initially, the outer shell 650 is fully rotated counter-clockwise, thus situating the release stop wall 660 in contact with the stop lug 634. This places the primary pawl apertures 654 into alignment directly above the primary pawls 614. The primary pawls 614 are then able to flex freely outward. The strap component 690 may then be pushed directly into the fastener until the loop is situated snugly around the workpiece.

As the strap component 690 moves inward into the fastener, the primary pawls 614 are repeatedly deflected outward into the pawl apertures 654 as they skip over the helical threads 698. Concurrently, the secondary pawl threads 671 are engaging and disengaging with the ratchet threads 699 on the underside of the strap component 690. When the strap component 690 is snugly fitted around the workpiece, the closure/loop may be tensioned by rotating the outer shell 650 clockwise until the tensioning stop wall 662 comes into contact with the stop lug 634. The primary pawl apertures 654 are then moved out of alignment with the primary pawls 614 and the solid sections configured to prevent the pawls from flexing outward. Thus, the primary pawl threads (not shown) are retained in engagement with the strap helical threads 698. Further rotation of the outer shell 650 causes the tensioning stop wall 662 to drive the stop lug 634, thereby driving the inner shell 610 clockwise to tension the closure/loop. In this configuration, the secondary pawl teeth 671 are locked in ratchet-like engagement with the strap ratchet teeth 699, thereby preventing any inadvertent loosening of the closure/loop.

To release the fastener system, the user may depress the release tab 672 on the secondary pawl 670 and rotates the outer shell 650 counter-clockwise until the release stop wall 660 contacts stop lug 634, at which point the strap component can be removed directly from the fastener component.

### Seventh Embodiment

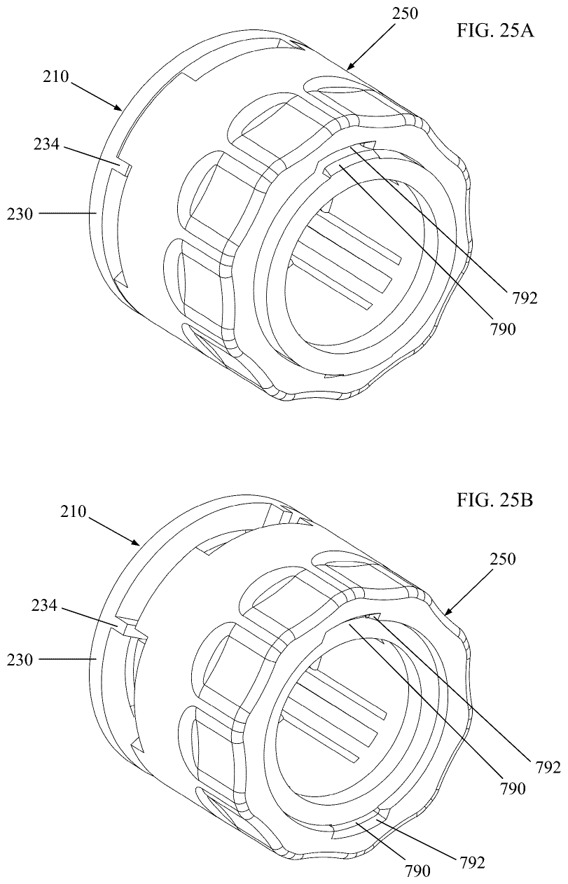

Illustrated in FIGS. 25A-25B are oblique views of a fastener system with an extraction alignment mechanism in an unlocked and locked configuration, respectively, in accordance with one embodiment of the present invention. This embodiment of the fastener system is substantially identical to the second embodiment (FIGS. 6-8) with the exception of the additional extraction alignment mechanism. The extraction alignment mechanism is configured to lock the outer shell 250 and inner sleeve 214 in alignment when the fastener is extracted from a bolt, hose, or other threaded object. When the outer shell 250 and inner sleeve 214 are locked in alignment, the primary pawls 214 and pawl apertures 254 also locked in alignment, which (a) enables the fastener 200 to be easily removed from a bolt using a linear motion, and (b) enables the fastener to be easily inserted or reinserted onto the bolt using a linear motion. Without this extraction alignment mechanism, the outer shell 250 may rotate about the sleeve 214 in the absence of the bolt, which could inadvertently lock the primary apertures in the rotational mode before the user has even put the fastener on the bolt.

The extraction alignment mechanism includes a detent 790 projecting from the inner shell 215 and matching extraction recess 792 or channel on the inner surface of the outer shell 250. When the fastener 200 is tensioned against a workpiece, for example, the user can remove the fastener by rotating the fastener counter-clockwise until the primary pawls are free to deflect radially outward (FIG. 25A) and then pull the outer shell longitudinally off the bolt. This longitudinal motion causes the outer shell 250 to move back (FIG. 25B) and the extraction recess 792 to capture the detent 790, thereby locking the outer shell 250 and inner sleeve 214 together. The locking force is provided by the friction fit between the detent 790 and extraction recess 792.

When installing the fastener on a bolt, the user need only reverse the processes and drive the outer shell 250 toward the bolt head until the detent 790 moves out of the extraction recess 792, which unlocks the extraction alignment mechanism. While the extraction alignment mechanism is shown in relation to the second embodiment of the fastener system 200, the mechanism is applicable to all embodiments of the present invention.

As to further discussion of the manner of usage and operation of the present invention, the same should be apparent from the above description. Accordingly, no further discussion relating to the manner of usage and operation will be provided. With respect to the above description then, it is to be realized that the optimum dimensional relationships for the parts of the invention, to include variations in size, materials, shape, form and function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Although the description above contains many specifications, these should not be construed as limiting the scope of the invention but as merely providing illustrations of some of the presently preferred embodiments of this invention.

Therefore, the invention has been disclosed by way of example and not limitation, and reference should be made to the following claims to determine the scope of the present invention.

I/We claim:

1. A linear-rotational fastener configured to engage a threaded object with helical threads, the fastener comprising:
an outer shell comprising:
a) a shell wall; and
b) a plurality of apertures in the shell wall;
an inner sleeve concentrically concealed within the outer shell, the sleeve comprising:
a) a plurality of primary pawls, each of the primary pawls configured to selectively engage the helical threads of the threaded object; wherein the primary pawls are configured to rotate between a biased position seated within the helical threads of the threaded object and a deflected position above the helical threads of the threaded object; and
b) a flange configured to transfer a linear force from the outer shell to the inner sleeve in a direction longitudinally aligned with the threaded object;
wherein the apertures are configured to align with the primary pawls when the primary pawls are in the deflected position, and the shell wall is configured to align with the primary pawls when the primary pawls are in the biased position; and
wherein the rotation of the outer shell causes the shell wall to abut the primary pawls when the primary pawls fail to seat within helical threads of the threaded object, thereby rotating the primary pawls until they are seated within helical threads of the threaded object.

2. The linear-rotational fastener of claim 1, wherein the plurality of primary pawls are configured to:
skip over the helical threads in a linear mode, and
seat against, and rotate with, the helical threads in a rotational mode.

3. The linear-rotational fastener of claim 2, wherein the plurality of primary pawls comprise a helical thread portion configured to engage the helical threads of the threaded object.

4. The linear-rotational fastener of claim 3, wherein each of the plurality of primary pawls is attached to the inner sleeve with a hinge, wherein the each of the plurality of primary pawls is configured to pivot away from the threaded object to skip over the helical threads in the linear mode.

5. The linear-rotational fastener of claim 4, wherein each of the plurality of primary pawls is integrally formed into the inner sleeve, wherein the hinge is a flexure joint.

6. The linear-rotational fastener of claim 4, wherein the outer shell is configured to rotate relative to the inner shell between:
a first position in which each of the plurality of apertures in the outer sleeve is aligned with one of the plurality of primary pawls in the linear mode, thereby receiving the primary pawl as it skips over the helical threads of the threaded object; and
a second position in which the outer sleeve blocks the plurality of the primary pawls from skipping over the helical threads of the threaded object.

7. The linear-rotational fastener of claim 6, further comprising a stop lug, release stop wall, and a tensioning stop wall; wherein rotation of the outer shell relative to the inner sleeve is constrained to the angle of rotation of the stop lug between the release stop wall and the tensioning stop wall.

8. The linear-rotational fastener of claim 6, further comprising an adapter configured to couple a first threaded object with male threads and a second threaded structure with female threads, wherein the plurality of primary pawls are configured to engage the male threads of the first threaded object, and wherein the adapter is concentrically concealed within the inner sleeve.

9. The linear-rotational fastener of claim 8, wherein the male threads are hose threads and the female threads are hose threads.

10. The linear-rotational fastener of claim 9, further comprising an elastomer washer interposed between the male threads of the first threaded object and the adapter.

11. The linear-rotational fastener of claim 6, further comprising at least one secondary pawl, each of the at least one secondary pawls comprising a ratchet thread configured to:
enable the threaded object to slide into the fastener when configured in the linear mode; and
inhibit the threaded object from sliding out of the fastener when configured in the linear mode.

12. The linear-rotational fastener of claim 11, wherein the at least one secondary pawl is integrally formed into the inner sleeve with a flexure joint.

13. The linear-rotational fastener of claim 11, wherein the at least one secondary pawl is rigidly attached to a release tab, wherein the release tab is configured to disengage the ratchet thread to remove the threaded object from the fastener.

14. The linear-rotational fastener of claim 11, wherein the at least one secondary pawl is configured to catch a second ratchet thread on the inner sleeve.

15. The linear-rotational fastener of claim 11, wherein the at least one secondary pawl is configured to catch a second ratchet thread in a longitudinal channel in the threaded object.

16. The linear-rotational fastener of claim 11, wherein the at least one secondary pawl is configured to catch a second ratchet thread on a dual-threaded bolt.

17. The linear-rotational fastener of claim 1, further comprising an extraction alignment mechanism configured to lock the outer shell and inner sleeve together in a linear mode of operation.

18. The linear-rotational fastener of claim 17, wherein the extraction alignment mechanism comprises a detent and an extraction recess configured to capture the detent during extraction of the threaded object from the fastener.

19. A linear-rotational fastener configured to engage a threaded object with helical threads, the fastener comprising:
an outer shell comprising:
a) a shell wall; and
b) a plurality of apertures in the shell wall;
an inner sleeve concentrically concealed within the outer shell, the sleeve comprising a plurality of primary pawls, each of the primary pawls configured to selectively engage the helical threads of the threaded object; wherein the primary pawls are configured to rotate between a biased position seated within the helical threads of the threaded object and a deflected position above the helical threads of the threaded object; and
wherein the apertures are configured to align with the primary pawls when the primary pawls are in the deflected position; and
wherein rotation of the outer shell causes the shell to abut the primary pawls when the primary pawls fail to seat within helical threads of the threaded object, thereby rotating the primary pawls until they are seated within helical threads of the threaded object.

20. A linear-rotational fastener configured to engage a threaded object with helical threads, the fastener comprising:
an outer shell comprising at least one aperture;
an inner sleeve concentrically concealed within the outer shell, the sleeve comprising at least one primary pawl, each primary pawl configured to selectively engage the helical threads of the threaded object; wherein the at least one primary pawl is configured to rotate between a biased position seated within the helical threads of the threaded object and a deflected position above the helical threads of the threaded object; and
wherein the at least one aperture is configured to align with the at least one primary pawl when in the deflected position; and
wherein rotation of the outer shell causes the shell to abut the at least one primary pawl if and when it fails to seat within helical threads of the threaded object, thereby rotating the at least one primary pawl until it seats within helical threads of the threaded object.
